(19) United States
(12) Patent Application Publication
(10) Pub. No.: US 2007/0044273 A1
(43) Pub. Date: Mar. 1, 2007

(54) Running Wheel Of A Roller Such As A Caster Wheel Or A Fixed Wheel

(76) Inventor: Manfred Milbredt, Remscheid (DE)

Correspondence Address: ST. ONGE STEWARD JOHNSTON & REENS, LLC, 986 BEDFORD STREET, STAMFORD, CT, 06905-5619, US

(21) Appl. No.: 11/552,388

(22) Filed: Oct. 24, 2006

Related U.S. Application Data
(63) Continuation of application No. PCT/EP05/51474, filed on Apr. 1, 2005.

(30) Foreign Application Priority Data
Apr. 24, 2004 (DE) 102004020072.6

(51) Int. Cl. B60B 33/00

(52) U.S. Cl. 16/45

(57) ABSTRACT

The invention relates to a running wheel of a roller such as a caster wheel or a fixed caster, comprising a hub body, in particular a hub body made of polyamide, and a running surface. The hub body is produced according to a plastic injection method. In order to further develop the generic running wheel and to improve the production and advantages of use, the running surface is embodied on a tube part and the tube part comprises a filling made of plastic and/or rubber material.

### CROSS-REFERENCE TO RELATED APPLICATIONS

The present application is a continuation of pending International patent application PCT/EP2005/051474 filed on Apr. 1, 2005, 2004 which designates the United States and claims priority from German patent application 10 2004 020 072.6 filed on Apr. 24, 2004, the content of which is incorporated herein by reference.

### FIELD OF THE INVENTION

The invention relates in first instance to a running wheel of a roller such as a caster wheel or a fixed caster, comprising a hub body, in particular a hub body made of polyamide, and a running surface, the hub body being produced in a plastics injection-molding process

### BACKGROUND OF THE INVENTION

Running wheels for caster wheels or fixed casters have long been known from the prior art. For example, running wheels which have a hub body that consists of metal and at the same time is carrier of a tyre consisting of plastic are available. Hub bodies of running wheels that consist of a plastics material and likewise are carrier of a plastic tyre are also known. EP 0 577 954 A1 describes such a running wheel for rollers.

An object of the invention is to provide a running wheel of the type stated at the beginning with an advantageous configuration in terms of its production and/or to provide such a running wheel with an improved structural design.

### SUMMARY OF THE INVENTION

This object is achieved first and foremost in the case of a running wheel of a roller with the features of claim 1, it being provided that the running surface is formed on a tube part and that the tube part has a filling of a plastics material and/or rubber material. Such a configuration produces a running wheel, for example for a caster wheel or a fixed caster, which can easily be structurally adapted for specific applications. For instance, the material of the tube part can be selected with regard to wear resistance and/or static discharge and/or esthetic requirements and/or production requirements, while the filling may be selected primarily from aspects such as running comfort and/or low-cost configuration and/or emergency running properties. The filling is preferably formed by a comparatively soft plastics material, while the tube material is formed by a plastic that is wear-resistant and consequently generally harder. The filling, which is preferably completely enclosed in the tube material, is correspondingly disposed between the running surface and the hub body of the roller and absorbs loads possibly occurring as a result of shock or compression during the running operation of the roller. The roller may for example be the roller on a hospital bed or the like. The absorption, or at least damping, of the loads referred to presupposes, as also preferably provided, that the tube part can in its portion forming the running surface move in an elastically compensating manner, in spite of being formed from a comparatively harder material, on account of being as it were freely mounted (though supported on the hub side by the filling).

The subjects of the further claims are explained below with reference to the subject matter of claim 1, but may also be of significance in their independent formulation. For instance, it proves to be advantageous that, in cross-section, the tube part is partly enclosed by the hub body. This has the effect that the tube part is virtually flanked by the hub body, in a direction corresponding to the axis of rotation of the running wheel. A further advantageous configuration provides that the hub body encloses the tube part in a positively connecting manner radially outward in the sense of (counteracting) detachment of the tube part from the hub part. This is correspondingly a positive connection in the radial direction. It is preferably provided that the tube part consists of a—comparatively harder—polyurethane material. “Comparatively harder” means here that the material is harder than the filling, but not necessarily harder than the material of the hub body, or generally softer than the material of the hub body. For certain applications in which an altogether “soft configuration” is rather more important than high wear resistance, it is also possible however to provide a soft plastic form of the running surface, that is of the tube part.

The designation tube part is chosen here only to characterize the form taken by the body. It is a tubular enveloping body. In particular, this chosen designation is not to be understood as restrictive with regard to the production of the tube body.

By contrast, the hub body is preferably produced from a hard plastic, and more preferably here from a polyamide material, so that the hub body is, as mentioned, generally made to be harder than the tube part. The filling of the tube part with a soft plastic creates a shock-absorbing soft core. It may also be provided that the tube part has functional elements. These may be, for example, reinforcing elements. These advantageously increase the compressive load-bearing limits of the running wheel. To be regarded as a further advantage is that the functional elements serve for discharging an electrostatic charge possibly occurring, in order for example to provide a device that is equipped with such a running wheel with advantages in terms of safety. The functional elements may in particular be integrated into the material of the tube part in the form of reinforcing fibers or reinforcing filaments. For example also as metal filaments. The metal filaments advantageously help here to discharge an electrostatic charge possibly occurring. In this form, the functional elements are preferably disposed in the tube body in a homogeneously distributed manner. More preferably, they are not oriented here, but randomly disposed.

More preferably, the hub body has a hub web, which is associated with the running surface and merges into a mounting web which is widened in comparison with said hub web and is adapted in its width to the width of the running surface. As a result, the tube part, which is made to be softer than the hub body, is supported in a widened portion of the hub body of a harder form. It is advantageous here if the width of the mounting portion corresponds to the width of the running surface and/or the total width of the tube part. A cross-sectional area of the tube part corresponds in its size to the cross-sectional area of the mounting portion. An embodiment in which the cross-sectional area of the tube part is greater than the greatest cross-sectional area (seen parallel to the axis of rotation of the running wheel) of the tube part is currently preferred. However, it is also possible for said cross-sectional area of the tube part to be smaller than the cross-sectional area of the mounting portion (which is also seen parallel to the axis of rotation of the running wheel). A reduction or increase in the ratio of the cross-sectional areas to each other also has an effect on the rolling properties of the running wheel.

With regard to the filling of the tube part to form the preferably shock-absorbing core, to this extent therefore a soft core, it is provided that this filling is introduced into the tube part in the course of the plastics injection-molding process.

The invention also relates to a method for producing a running wheel of a roller such as a caster wheel or a fixed caster, comprising a hub body, the hub body being produced for example in a plastics injection-molding process, and a running surface being associated with the hub body. In order to develop such a method for producing a running wheel in an advantageous manner in terms of production, it is proposed that the running surface is formed on a tube part produced in the plastics injection-molding process and that this tube part is then filled with a plastics material and/or rubber material, likewise in the plastics injection-molding process. This provides a method for producing a running wheel with which different requirements can be satisfied in an efficient manner. For instance, a particularly suitable material can be selected for the tube part with regard to the running surface region. Also with regard to a positive material bond with the hub body, as preferably provided. Furthermore, a wide variety of plastics, including in a mixture, can be used as the filling, without having to consider the aspects mentioned such as suitability of the running surface and bonding with the hub body. The tube part with the filling may be produced first, already in the closed circular form, and then the hub body molded on. This method makes it possible to produce a running wheel for a roller, such as for example a caster wheel or a fixed caster, which in a preferred application has a shock- or impact-absorbing filling and, as a result, can ensure damped running operation along with an efficient production procedure. Such rollers are used for example on hospital beds.

The filling may be injected via the same injection nozzle (or the same injection nozzles) with which the material for the tube part is also injected.

In a development, the invention also proposes that the filled tube part is produced first and that the hub body is molded on in such a manner that the hub body partly encloses the tube part. Assuming that the materials are appropriately selected, a positive material bond between the tube part and the hub body is immediately produced when the hub body is molded on. The fact that the hub body is molded onto the tube part in such a manner that it partly encloses it also has the effect of producing a positive kind of connection. Moreover, the materials that have already been specified further above are preferably used.

The hub body may in principle also be formed as a metal part. To this extent, a two-part form of the hub body is then also preferred.

### BRIEF DESCRIPTION OF THE DRAWINGS

An exemplary embodiment of the invention is explained below with reference to the drawing, in which:

FIG. 1 shows the article according to the invention in an application as a perspectively represented caster wheel or fixed caster;

FIG. 2 shows a partial section along the line II-II in FIG. 1 and

FIG. 3 shows the enlarged detail as indicated by III in FIG. 2.

### DETAILED DESCRIPTION OF THE INVENTION

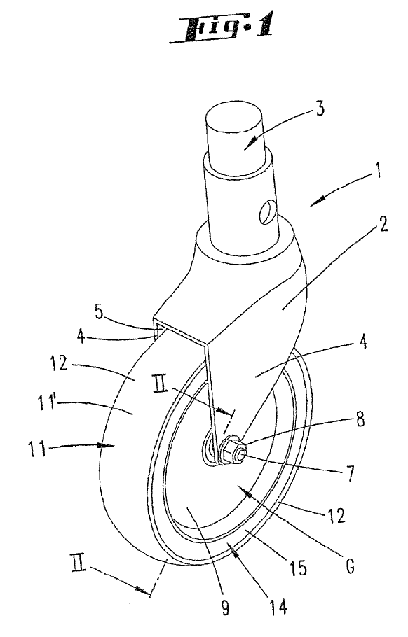

Presented and described, in first instance with reference to FIG. 1, is a roller 1, which may be formed for example as a caster wheel or fixed caster.

The roller 1 has in a known manner a running roller fork 2, from which a cylindrically configured mounting pin 3 vertically protrudes. With its fork legs 4, which are disposed such that they lie congruently opposite each other, the running roller fork 2 flanks a running wheel 6 mounted in a fork cavity 5. Used in a known manner for mounting the running wheel 6 is a running roller axle 7, which passes centrally through the running wheel 6 and is secured to the fork legs 4 in a known manner. That is by fixing by means of screw nuts 8.

Such a running roller or caster wheel is used for example on hospital beds, transporting devices or the like, these rollers then being mounted in the customary manner.

The running wheel 6 has a central hub body 9, which has a centrally disposed bearing bore 10 for the running roller axle 7 passing through it. This hub body 9 preferably consists of a hard plastic produced in a plastics injection-molding process, such as for example a polyamide material.

The running surface 11′ of the running wheel 6 is formed by a tube part 11, on which the hub body 9 is molded. The tube part 11 is surrounded by the hub body 9 in a positively connecting manner.

The material composition of the tube part 11 provides that it consists of a hard plastic, for example a polyurethane material. However, the hardness of the material of the tube part is less here than the hardness of the material of the hub part. While a hardness in the range from 35 to 40 D, preferably 42 D±5, is provided for the tube part, a hardness in the range from 50 to 80 A, preferably 60 A±10, is provided for the filling.

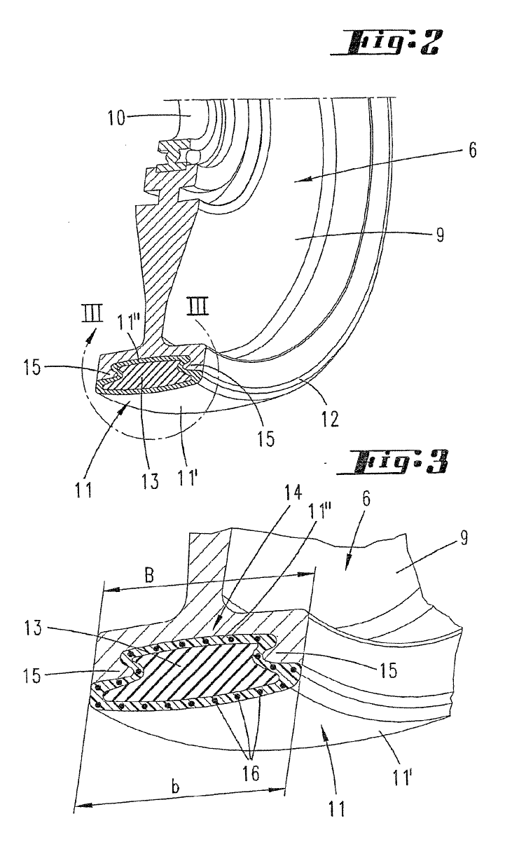

As can be gathered from FIGS. 2 and 3, the lateral surface 12 of the tube part 11 encloses a filling 13, which is introduced into the tube part 11 by means of a plastics injection-molding process and for its part consists of a soft plastics material and/or rubber material. This soft filling 13 absorbs shock loading or the like during rolling operation of the running wheel or the roller 1.

As a basis for receiving the tube part 11, the hub body 9 has on its outer peripheral region a widened mounting portion 14, running in the circumferential direction. This portion has a width B, which corresponds to the width b of the running surface 11′ of the tube part 11. To achieve a positive connection between the mounting portion 14 and the tube part 11 also in the radially outward direction, the mounting portion 14 has, seen in the axial direction of the running roller 1, mutually opposing flanks 15, which for their part constrict the tube part 11 in the mutually facing contact region and, as a result, form in the mounting portion 14 above the contact region a tube base 11″ that is widened in relation to the contact region. Furthermore, the flanks 15 form in each case at the peripheral region of the hub body 9 peripheral supporting zones for the running surface 11′, which for its part is formed, seen in cross-section, as a convexly outwardly protruding freely mounted cover, which with the outer sides of its molded-on and oppositely disposed walls defines the width b.

To strengthen the material of the tube part 11, reinforcing functional elements in the form of metal filaments 16 are provided in the tube part 11. These are only schematically reproduced in the representation. In the specific exemplary embodiment, it is possible in this way not only to achieve a reinforcement of the material itself, but at the same time an improvement with regard to the discharge of electrostatic charges. It may also be provided that the hub body 9 has a metal part (not represented) for passing on/discharging such electrostatic charges.

The method for producing the running wheel 6 of the roller 1 provides in first instance that the tube part is produced in the plastics injection-molding process from a PU material. In the same operation, the tube part 11 is provided in the plastics injection-molding process with the filling 13 in the form of plastics material and/or rubber material. After that, the hub body 9 is molded onto the tube part, partly enclosing the latter, to produce a positive connection in the direction of the axis of rotation of the running wheel. Consequently, the hub body 9 has on its circumferential wall a running portion of a soft form that yields to compressive loading, in the form of the filled tube part.

All disclosed features are (in themselves) pertinent to the invention. The disclosure content of the associated/accompanying priority documents (copy of the prior application) is also hereby incorporated in full in the disclosure of the application, including for the purpose of incorporating features of these documents in claims of the present application.

1. Running wheel of a roller such as a caster wheel or a fixed caster, comprising a hub body, in particular a hub body made of polyamide, and a running surface, the hub body being produced in a plastics injection-molding process, characterized in that the running surface is formed on a tube part likewise produced in the plastics injection-molding process and in that the tube part has a filling of a plastics material and/or rubber material.

2. Running wheel according to claim 1, characterized in that, in cross-section, the tube part is partly enclosed by the hub body.

3. Running wheel according to claim 2, characterized in that the hub body encloses the tube part in a positively connecting manner.

4. Running wheel according to claim 1, characterized in that the tube part consists of a hard plastic.

5. Running wheel according to claim 1, characterized in that the tube part consists of polyurethane.

6. Running wheel according to claim 1, characterized in that the tube part is filled with a soft plastic.

7. Running wheel according to claim 1, characterized in that the tube part has functional elements.

8. Running wheel according to claim 7, characterized in that the functional elements are reinforcing elements.

9. Running wheel according to claim 7, characterized in that the functional elements serve for discharging an electrostatic charge.

10. Running wheel according to claim 8, characterized in that the functional elements are formed as reinforcing fibers or reinforcing filaments.

11. Running wheel according to claim 10, characterized in that the functional elements are formed as metal filaments.

12. Running wheel according to claim 1, characterized in that the hub body has a hub web, which is associated with the running surface and merges into a mounting portion which is widened in comparison with said hub web and is adapted in its width to the width of the running surface.

13. Running wheel according to claim 12, characterized in that the cross-sectional area of the tube part corresponds to the cross-sectional area of the mounting portion.

14. Running wheel according to claim 12, characterized in that the cross-sectional area of the tube part is greater than the cross-sectional area of the mounting portion.

15. Running wheel according to claim 1, characterized in that the filling is introduced in the plastics injection-molding process.

16. Method for producing a running wheel of a roller such as a caster wheel or a fixed caster, comprising a hub body, the hub body being produced for example in a plastics injection-molding process, and a running surface being associated with the hub body, characterized in that, to form the running surface in the plastics injection-molding process, a tube part is produced and the tube part is filled with a filling of a plastics material and/or rubber material in the plastics injection-molding process.

17. Method according to claim 16, characterized in that the filled tube part is produced first and then the hub body is molded onto the tube part.

18. Method according to claim 17, characterized in that the hub body is molded on in such a way that the hub body partly encloses the tube part.

19. Method according to claim 16, characterized in that the hub body and/or the tube part is produced from a hard plastic such as polyamide.
